(19) United States
(12) Patent Application Publication
(10) Pub. No.: US 2012/0210934 A1
(43) Pub. Date: Aug. 23, 2012

(54) PRINTING DEVICE

(75) Inventors: Shinichi NAKAMURA, Okaya (JP); Yoichi MIYASAKA, Suwa (JP)

(73) Assignee: SEIKO EPSON CORPORATION, Tokyo (JP)

(21) Appl. No.: 13/400,807

(22) Filed: Feb. 21, 2012

(30) Foreign Application Priority Data
Feb. 21, 2011 (JP) 2011-034863

(51) Int. Cl. B05C 11/00

(52) U.S. Cl. 118/708

(57) ABSTRACT

A printing device includes a plurality of treatment devices, a transporting part, a detection part, a storage unit, a determination part and a controller. Each of the treatment devices is configured and arranged to perform a treatment on a base material. The transporting part is configured and arranged to transport the base material between the treatment devices. The detection part is configured and arranged to perform a detecting action in placement parts in the treatment devices, the detection part being provided to the transporting part. The storage unit is configured and arranged to correlate and store a position and detection data detected by the detection part. The determination part is configured and arranged to determine presence of the base material in the treatment devices based on the data stored in the storage unit. The controller is configured to determine a treatment action based on determination result of the determination part.

### CROSS-REFERENCE TO RELATED APPLICATIONS

This application claims priority to Japanese Patent Application No. 2011-034863 filed on Feb. 21, 2011. The entire disclosure of Japanese Patent Application No. 2011-034863 is hereby incorporated herein by reference.

### BACKGROUND

1. Technical Field

The present invention relates to a printing device.

2. Related Art

Recently, there has been focus on liquid discharge devices which use ultraviolet ray curing ink cured by being irradiated with ultraviolet rays to form an image or a pattern on a recording medium. Ultraviolet ray curing ink has preferred characteristics as print ink in that it cures extremely slowly until being irradiated with ultraviolet rays, and cures rapidly when irradiated with ultraviolet rays. Since no solvent is volatilized during curing, another merit is that there is little effect on the environment.

Furthermore, ultraviolet ray curing ink exhibits high adherability with various recording media, depending on the composition of the vehicle. This ink also has other excellent characteristics, such as chemical stability after curing; high adhesiveness, chemical resistance, weather resistance, friction resistance, and the like; and resistance to outdoor environments. Therefore, in addition to paper, resin films, metal foil, and other thin sheet-shaped recording media, images can also be formed on the label surfaces of recording media, textile products, and other media having somewhat three-dimensional surface shapes.

A technique has been disclosed in which the above-described ultraviolet ray curing ink is used in a droplet discharge system to print a manufacturing number, a manufacturing company, and other attribute information in the IC on a substrate (for example, Japanese Laid-Open Patent Publication No. 2003-080687). When the above-described printing process is performed on a substrate, the substrate is sequentially conveyed through a droplet discharge device, a pretreatment device, and other various treatment devices associated with printing.

### SUMMARY

However, conventional techniques such as the one described above have the following problems.

When another substrate remains in the path of the substrate being conveyed, it is a hindrance to the conveying of the substrate. In view of this, one option is to provide a sensor or the like for detecting the presence of substrates in the treatment devices, but in this case, the size and cost of the device are increased.

The present invention was devised in view of such matters, and an object thereof is to provide a printing device which can contribute to reducing the size and cost of equipment.

To achieve the object described above, the present invention employs the following configuration.

A printing device according to one aspect of the present invention includes a plurality of treatment devices, a transporting part, a detection part, a storage unit, a determination part and a controller. Each of the treatment devices is configured and arranged to perform a treatment on a base material. The transporting part is configured and arranged to transport the base material between the treatment devices. The detection part is configured and arranged to perform a detecting action in placement parts in the treatment devices, the detection part being provided to the transporting part. The storage unit is configured and arranged to correlate and store a position and detection data detected by the detection part. The determination part is configured and arranged to determine presence of the base material in the treatment devices based on the data stored in the storage unit. The controller is configured to determine a treatment action based on determination result of the determination part.

Therefore, in the printing device of the above described aspect of the present invention, the detection part for detecting the presence of the base material in the placement parts is provided to a transporting device which can move relative to the treatment devices, and there is no need to provide a detection device for each treatment device; therefore, it is possible to contribute to reducing the size and cost of equipment.

In the above described aspect of the present invention, when the base material is transported to a treatment device, in the case that the storage unit is referenced and no base material remains, for example, in the placement part of that treatment device, the base material is transported to the treatment device by the transporting part in order to perform a predetermined process on the base material, and in the case that a base material remains in the placement part of that treatment device, for example, transporting of the base material to that treatment device can be stopped in order to avoid interference with the existing base material.

The above described aspect of the present invention can suitably employ a configuration in which the controller is configured to control driving of the transporting part during an initial action to determine the presence of the base material in the treatment devices.

It is thereby possible in the above described aspect of the present invention to perceive the presence of base materials in the treatment devices during the initial action (during startup) of the printing device, and interference between base materials during the initial action can be avoided.

The above described aspect of the present invention can suitably employ a configuration in which an adjustment part is provided to adjust the position of the base material detected by the detection part, based on layout information of a member disposed on a surface of the base material.

In the above described aspect of the present invention, there is thus no need to separately and manually input the detected position in the base material, erroneous input and other mistakes can be eliminated, and operating efficiency can be improved.

The controller suitably employs a configuration in which, based on respective treatment histories in the treatment devices, the controller is configured to cause the base material which is in one of the treatment devices to be transported to another of the treatment devices that performs an unloader process as the treatment action, when a predetermined time has elapsed, and to transition to the treatment action after confirming that treatment by the treatment device is complete, when a predetermined time has not elapsed.

In the above described aspect of the present invention, in the case that a base material is present in a treatment device, the next base material to undergo processing can thus be conveyed (transported) to that treatment device by performing an unloader process assuming that processing on the first base material is complete when a predetermined time has elapsed. When a predetermined time has not elapsed, a transition to the next process is made after confirming that processing by that treatment device is complete, and it is therefore possible to avoid conveying the base material before processing is complete and causing quality defects.

A configuration can be suitably employed in which the treatment devices include a loader device that transports a new base material to be processed, and a pretreatment device that performs a predetermined pretreatment on the base material transported from the loader device, and the controller is configured to cause the base material to be transported from the loader device to the pretreatment device based on the determination result of the determination unit.

It is thereby possible in the above described aspect of the present invention to avoid interference between the base material remaining in the treatment device and the new base material when a new base material conveyed in from the loader device to undergo processing is conveyed to the treatment device.

The above described aspect of the present invention can suitably employ a configuration in which the treatment devices include a discharge device configured and arranged to discharge droplets on a semiconductor device provided to a surface of the base material.

It is thereby possible in the above described aspect of the present invention to deposit or print a print pattern indicating attribute information or the like of the semiconductor device with a predetermined print quality and low cost.

A printing device according to another aspect of the present invention includes a plurality of treatment devices, a transporting part, a detection part, a storage unit, a determination part and a controller. The treatment devices are configured and arranged to perform treatments related to printing on a base material. The treatment devices include a discharge device configured and arranged to discharge droplets of a liquid substance that is curable by active light onto the base material. The transporting part is configured and arranged to transport the base material between the treatment devices. The detection part is configured and arranged to perform a detecting action in placement parts in the treatment devices, the detection part being provided to the transporting part. The storage unit is configured and arranged to correlate and store a position and detection data detected by the detection part. The determination part is configured and arranged to determine presence of the base material in the treatment devices based on the data stored in the storage unit. The controller is configured to determine a treatment action based on determination result of the determination part.

Therefore, in the printing device of the above described aspect of the present invention, the detection part for detecting the presence of the base material in the placement parts is provided to a transporting device which can move relative to the treatment devices, and there is no need to provide a detection device for each treatment device. It is therefore possible to contribute to reducing the size and cost of equipment.

In the above described aspect of the present invention, when the base material is conveyed to a treatment device, in the case that the storage unit is referenced and no base material remains, for example, in the placement part of that treatment device, the base material is conveyed to the treatment device by the transporting part in order to perform a predetermined process on the base material, and in the case that a base material remains in the placement part of that treatment device, for example, conveying of the base material to that treatment device can be stopped in order to avoid interference with the existing base material.

The present specification includes a range in which the relative movement direction and the orthogonal direction are misaligned by errors and the like caused by manufacturing and assembling.

### BRIEF DESCRIPTION OF THE DRAWINGS

Referring now to the attached drawings which form a part of this original disclosure:

FIG. 1A is a descriptive drawing showing the configuration of a printer, and FIG. 1B is a schematic plan view showing a droplet discharge device;

FIGS. 2A to 2C contain schematic views showing the feeding part;

FIG. 3A is a schematic perspective view showing the configuration of the application part, and FIG. 3B is a schematic side view showing the carriage;

FIG. 4A is a schematic plan view showing the head unit, and FIG. 4B is a partial schematic cross-sectional view for describing the structure of the droplet discharge head;

FIGS. 5A to 5C contain schematic views showing the storage unit;

FIGS. 6A to 6C contain drawings showing the configuration of the transporting part;

FIG. 7 is a drawing in which detection light is projected from the detection device on to a semiconductor substrate 1;

FIG. 8 is a block diagram showing a control system; and

FIG. 9 is a flowchart for showing the print method.

### DETAILED DESCRIPTION OF EXEMPLARY EMBODIMENTS

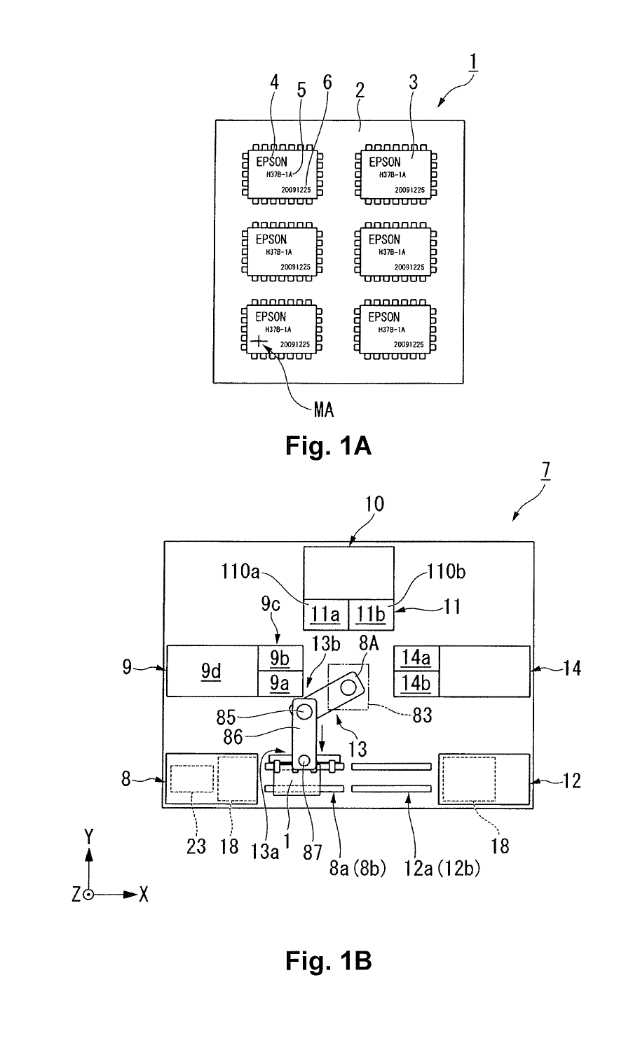

An embodiment of the printing device of the present invention is described hereinbelow with reference to FIGS. 1 through 9.

The following embodiment hereinbelow shows one aspect of the present invention but does not limit the invention, and can be modified as desired within the range of the technological ideals of the invention. In the following drawings, the actual structures are varied, as are the scales, numerical values, and other features of the structures, in order to make the configurations easier to understand.

### Semiconductor Substrate

First is a description of a semiconductor substrate, which is one example of something drawn (printed) using the printing device.

FIG. 1A is a schematic plan view showing a semiconductor substrate. A semiconductor substrate 1 as a base material comprises a substrate 2, as shown in FIG. 1A. The substrate 2 is preferably heat resistant and capable of having a semiconductor device 3 installed thereon, and a glass epoxy substrate, a paper phenol substrate, a paper epoxy substrate, or the like can be used as the substrate 2.

The semiconductor device 3 is installed on the substrate 2. Drawn on the semiconductor device 3 are a company logo 4, a model code 5, a manufacture number 6, and other markings (print pattern, predetermined pattern). These markings are drawn by the printing device which is described hereinafter.

### Printing Device

FIG. 1B is a schematic plan view showing the printing device.

The printing device 7 is configured primarily from a plurality of treatment devices for performing processes (treatments) pertaining to various printings, including a feeding part 8, a pretreatment part 9, an application part (a printing part) 10, a cooling part 11, a storage unit 12, a transporting part 13, a post-treatment part 14, and a controller CONT (see FIG. 8), as shown in FIG. 1B. The direction in which the feeding part 8 and the storage unit 12 are aligned, which is also the direction in which the pretreatment part 9, the cooling part 11, and the post-treatment part 14 are aligned, is designated as the X direction. The direction orthogonal to the X direction is designated as the Y direction, and the application part 10, the cooling part 11, and the transporting part 13 are disposed in alignment in the Y direction. The vertical direction is designated as the Z direction.

The feeding part 8 comprises a storage container in which a plurality of semiconductor substrates 1 are stored. The feeding part 8 comprises a relay location 8a, and the semiconductor substrates 1 are supplied from the storage container to the relay location 8a. A pair of rails 8b extending in the X direction are provided to the relay location 8a at substantially the same height as the semiconductor substrates 1 fed out from the storage container.

The pretreatment part 9 has the function of reforming the surface of the semiconductor device 3 while heating it. The manner in which droplets discharged by the semiconductor device 3 widen and the adhesiveness of the printed markings are adjusted by the pretreatment part 9. The pretreatment part 9 comprises a first relay location 9a and a second relay location 9b, and the semiconductor substrate 1 prior to processing is taken from the first relay location 9a or the second relay location 9b to have its surface reformed. The pretreatment part 9 then moves the semiconductor substrate 1 after processing to the first relay location 9a or the second relay location 9b, where the semiconductor substrate 1 is kept queued. The first relay location 9a and the second relay location 9b together constitute a relay location 9c. The location within the pretreatment part 9 where pretreatment is performed constitutes a pretreatment location 9d.

The cooling part 11 is disposed in the relay location of the application part 10, and the cooling part 11 has the function of cooling semiconductor substrates 1 that have been heated and surface-reformed in the pretreatment part 9. The cooling part 11 has processing locations 11a, 11b, both of which hold and cool the semiconductor substrates 1. The processing locations 11a, 11b are appropriately referred to collectively as a processing location 11c.

The application part 10 discharges droplets onto the semiconductor device 3 to draw (print) markings, and the drawn markings have the function of solidifying or curing. The application part 10 moves a semiconductor substrate 1 prior to drawing from the cooling part 11 as a relay location, and performs a drawing process and a curing process. The application part 10 then moves the semiconductor substrate 1 to the cooling part 11, where the semiconductor substrate 1 is kept queued.

After the drawing process has been performed in the application part 10, the post-treatment part 14 performs a reheating process as a post-process on the semiconductor substrate 1 placed in the cooling part 11. The post-treatment part 14 comprises a first relay location 14a and a second relay location 14b. The first relay location 14a and the second relay location 14b together constitute a relay location 14c.

The storage unit 12 comprises a storage container capable of storing a plurality of semiconductor substrates 1. The storage unit 12 comprises a relay location 12a, and semiconductor substrates 1 are stored in the storage container from the relay location 12a. A pair of rails 12b extending in the X direction are provided to the relay location 12a at substantially the same height as the storage container that stores the semiconductor substrates 1. An operator conveys the storage container in which the semiconductor substrates 1 are stored out from the printing device 7.

The transporting part 13 is disposed in a location in the center of the printing device 7. A scalar robot comprising an arm part 13b is used as the transporting part 13. The distal end of the arm part 13b is provided with a grasping part 13a for grasping the side edge of the semiconductor substrate 1 in a cantilever while supporting the semiconductor substrate 1 from the rear surface (bottom surface). The relay locations 8a, 9c, 11, 14c, 12a are positioned within the movement range of the grasping part 13a. Therefore, the grasping part 13a can move the semiconductor substrates 1 among the relay locations 8a, 9c, 11, 14c, 12a. The controller CONT, which is a device for controlling the actions of the entire printing device 7, manages the action conditions of the various parts of the printing device 7. A command signal for moving the semiconductor substrate 1 is outputted to the transporting part 13. The semiconductor substrate 1 is thereby subjected to drawing while passing sequentially through the various parts.

The details of the various parts are described hereinbelow.

### Feeding Part

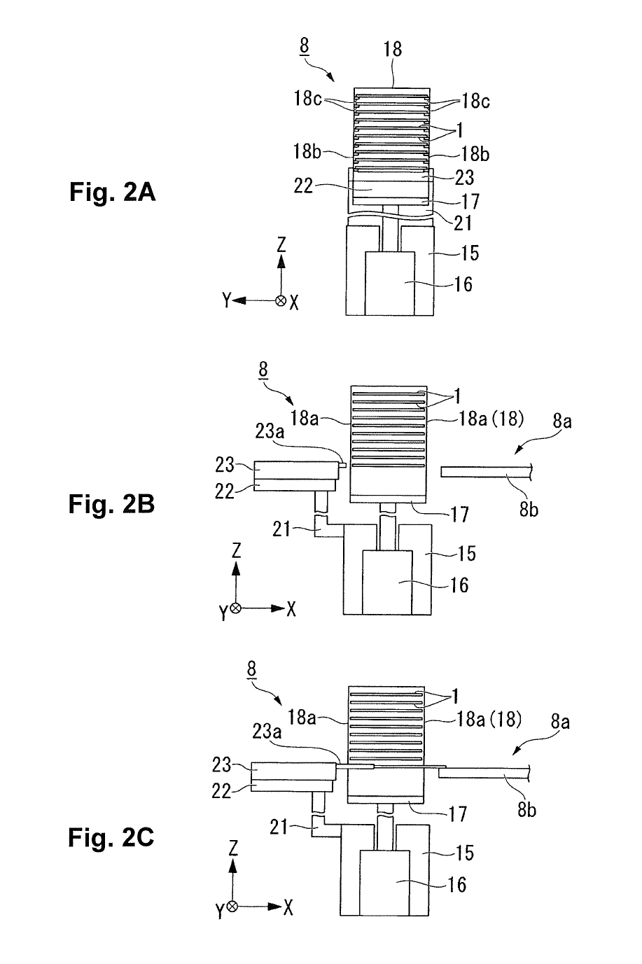

FIG. 2A is a schematic front view showing the feeding part, and FIGS. 2B and 2C are schematic side views showing the feeding part. The feeding part 8 comprises a base stand 15 as shown in FIGS. 2A and 2B. A raising/lowering device 16 is installed inside the base stand 15. The raising/lowering device 16 comprises a linear movement mechanism which actuates in the Z direction. A combination of a ball screw and a rotary motor, a combination of a hydraulic cylinder and an oil pump, and other mechanisms can be used as this linear movement mechanism. The present embodiment employs a mechanism that uses a ball screw and a step motor, for example. On the top side of the base stand 15, a raising/lowering plate 17 is installed in connection with the raising/lowering device 16. The raising/lowering plate 17 is capable of being raised and lowered by a predetermined movement amount by the raising/lowering device 16.

A rectangular parallelepiped storage container 18 is placed on top of the raising/lowering plate 17, and a plurality of semiconductor substrates 1 are stored in the storage container 18. Openings 18a are formed in both X-directional sides of the storage container 18, and the semiconductor substrates 1 can be inserted and taken out through the openings 18a. Protruding rails 18c are formed in the inner sides of side surfaces 18b positioned on both Y-directional sides of the storage container 18, and the rails 18c are disposed extending in the X direction. A plurality of the rails 18c are arrayed at intervals in the Z direction. The semiconductor substrates 1 are inserted along the rails 18c from the X direction or the −X direction, whereby the semiconductor substrates 1 are stored as being arrayed in the Z direction.

An extrusion device 23 is placed on an X-directional side of the base stand 15 via a support member 21 and a support stand 22. The extrusion device 23 is provided with an extrusion pin 23a which protrudes in the X direction by a linear movement mechanism similar to that of the raising/lowering device 16 and pushes the semiconductor substrates 1 out towards the rails 8b. Therefore, the extrusion pin 23a is placed at substantially the same height as the rails 8b.

Due to the extrusion pin 23a in the extrusion device 23 protruding in the +X direction as shown in FIG. 2C, the semiconductor substrates 1 positioned slightly higher in the +Z direction than the rails 18c are pushed out of the storage container 18 and moved onto the rails 8b where they are supported.

After a semiconductor substrate 1 has moved onto the rails 8b, the extrusion pin 23a returns to a standby position shown in FIG. 2B. Next, the raising/lowering device 16 lowers the storage container 18, causing the next semiconductor substrate 1 to be processed to move to a height facing the extrusion pin 23a. The extrusion pin 23a is then made to protrude, causing the semiconductor substrate 1 to move onto the rails 8b in the same manner as described above.

Thus, the feeding part 8 moves the semiconductor substrates 1 sequentially from the storage container 18 onto the rails 8b. After all of the semiconductor substrates 1 in the storage container 18 have been moved onto the extrusion device 23, the operator replaces the empty storage container 18 with a storage container 18 containing semiconductor substrates 1. Semiconductor substrates 1 can thereby be supplied to the feeding part 8.

### Pretreatment Part

The pretreatment part 9 performs pretreatment in the pretreatment location 9d on semiconductor substrates 1 that have been conveyed to the relay locations 9a, 9b. Possible examples of the pretreatment, which takes place in a heated state, include radiation with active light rays from a low-pressure mercury lamp, a hydrogen burner, an excimer laser, a plasma discharger, a corona discharger, or the like, for example. When a mercury lamp is used, the semiconductor substrate 1 is irradiated with ultraviolet rays, whereby the liquid repellency of the surface of the semiconductor substrate 1 can be reformed. When a hydrogen burner is used, the surface of the semiconductor substrate 1 can be roughened by partially deoxidizing the oxidized surface; when an excimer laser is used, the surface of the semiconductor substrate 1 can be roughened by partial melting and solidifying; and when plasma discharge or corona discharge is used, the surface of the semiconductor substrate 1 can be roughened by mechanical shaving. In the present embodiment, a mercury lamp is used, for example.

After pretreatment has ended, the pretreatment part 9 moves the semiconductor substrate 1 to the relay location 9c. The transporting part 13 then removes the semiconductor substrate 1 from the relay location 9c.

### Cooling Part

The cooling part 11 has heat sinks or other cooling plates 110a, 110b which are provided to the processing locations 11a, 11b respectively, and whose top surfaces are suction-holding surfaces for the semiconductor substrates 1.

The processing locations 11a, 11b (the cooling plates 110a, 110b) are positioned within the movement range of the grasping part 13a, and the cooling plates 110a, 110b are exposed in the processing locations 11a, 11b. Therefore, the transporting part 13 can easily place the semiconductor substrates 1 on the cooling plates 110a, 110b. After the cooling process has been performed on a semiconductor substrate 1, the semiconductor substrate 1 is kept queued either on the cooling plate 110a positioned in the processing location 11a or on the cooling plate 110b positioned in the processing location 11b. Therefore, the grasping part 13a of the transporting part 13 can grasp and move the semiconductor substrate 1 easily.

### Application Part

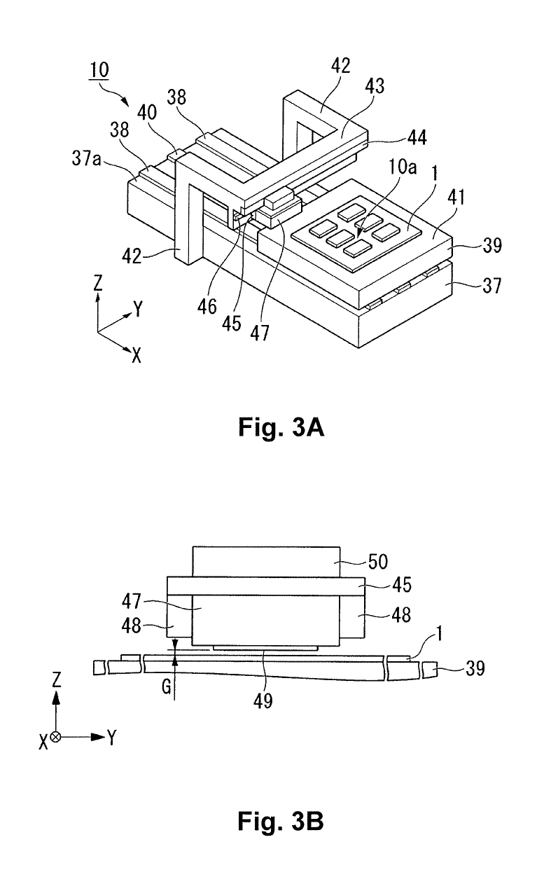

Next, the application part 10 for discharging droplets and forming markings on the semiconductor substrates 1 will be described according to FIGS. 3 through 6. There are various different types of devices for discharging droplets, but a device that uses the inkjet method is preferred. The inkjet method is capable of discharging tiny droplets and is therefore suitable for micromachining.

FIG. 3A is a schematic perspective view showing the configuration of the application part. Droplets are discharged by the application part 10 onto the semiconductor substrate 1. The application part 10 comprises a base stand 37 formed into a rectangular parallelepiped shape as shown in FIG. 3A. The direction in which the droplet discharge head and the discharge target move relative to each other when droplets are discharged is designated as the main scanning direction. The direction orthogonal to the main scanning direction is designated as the sub scan direction. The sub scan direction is the direction in which the droplet discharge head and the discharge target move relative to each other when a new line is begun. In the present embodiment, the Y direction (the second direction) is the main scanning direction and the X direction (the first direction) is the sub scan direction.

In the top surface 37a of the base stand 37, a pair of guide rails 38 extending in the X direction are provided protruding across the entire X direction. On the top side of the base stand 37 is attached a stage 39 comprising a linear movement mechanism (not shown) corresponding to the pair of guide rails 38. A linear motor, a screw-type linear movement mechanism, or the like can be used as the linear movement mechanism of the stage 39. In the present embodiment, a linear motor is employed, for example. The stage 39 is designed so as to advance and retreat at a predetermined speed along the X direction. The repetition of this advancing and retreating is referred to as scanning movement. Furthermore, a sub scan position detection device 40 is disposed in parallel with the guide rails 38 on the top surface 37a of the base stand 37, and the position of the stage 39 is detected by the sub scan position detection device 40.

A placement surface (placement part) 41 is formed on the top surface of the stage 39, and a suction-type substrate chuck mechanism (not shown) is provided on the placement surface 41. The semiconductor substrates 1 are placed on the placement surface 41, after which the semiconductor substrates 1 are fixed on the placement surface 41 by the substrate chuck mechanism.

The location of the placement surface 41 when the stage 39 is positioned toward the +X side, for example, is a relay location of the loading position or unloading position of the semiconductor substrates 1. The placement surface 41 is set up so as to be exposed within the active range of the grasping part 13a. Therefore, the transporting part 13 can easily place the semiconductor substrates 1 on the placement surface 41. After coating (drawing of markings) has been performed on the semiconductor substrates 1, the semiconductor substrates 1 are kept queued on the placement surface 41 which is a relay location. Therefore, the grasping part 13a of the transporting part 13 can easily grasp and move the semiconductor substrates 1.

A pair of support braces 42 are erected on the Y-directional sides of the base stand 37, and a guide member 43 extending in the Y direction spans between this pair of support braces 42. In the bottom side of the guide member 43, a guide rail 44 extending in the Y direction is provided protruding across the entire width in the X direction. A carriage (movement means) 45, which is attached so as to be capable of moving along the guide rail 44, is formed into substantially rectangular parallelepiped shape. The carriage 45 comprises a linear movement mechanism, and the linear movement mechanism can use the same mechanism as the linear movement mechanism provided to the stage 39, for example. The carriage 45 then scan-moves along the Y direction. A main scan position detection device 46 is disposed between the guide member 43 and the carriage 45, and the position of the carriage 45 is measured. A head unit 47 is provided to the bottom side of the carriage 45, and a droplet discharge head (not shown) is provided to the surface of the head unit 47 that faces the stage 39.

FIG. 3B is a schematic side view showing the carriage. The head unit 47 and a pair of curing units 48 as radiation parts are disposed on the side of the carriage 45 facing the semiconductor substrates 1 at equal intervals from the center of the carriage 45 in the Y direction, as shown in FIG. 3B. A droplet discharge head (a discharge head) 49 for discharging droplets is provided to the side of the head unit 47 facing the semiconductor substrates 1.

A storage tank 50 is disposed on the top side of the carriage 45 in the drawing, and a functional liquid is stored in the storage tank 50. The droplet discharge head 49 and the storage tank 50 are connected by a tube (not shown), and the functional liquid in the storage tank 50 is supplied to the droplet discharge head 49 through the tube.

The primary materials of the functional liquid are a resin material, a photopolymerization initiator as a curing agent, and a solvent or a dispersion medium. A functional liquid having a unique function can be formed by adding these primary materials a pigment, dye, or other colorant; a lyophilic, liquid-repellent, or other such surface-reforming material; or other functional materials. In the present embodiment, a white pigment is added, for example. The resin material of the functional liquid is a material that forms a resin film. The resin material is a liquid at room temperature, and is not particularly limited as long as it is a material that forms a polymer by being polymerized. Furthermore, a resin material of low viscosity is preferred, and it is preferably in the form of an oligomer. It is even more preferable to be in the form of a monomer. The photopolymerization initiator is an additive that acts on cross-linking groups of polymers to promote cross-linking reactions, and benzyl dimethyl ketal or the like can be used as the photopolymerization initiator, for example. The solvent or dispersion medium adjusts the viscosity of the resin material. By giving the functional liquid a viscosity at which it is easily discharged from the droplet discharge head, the droplet discharge head can discharge the functional liquid in a stable manner.

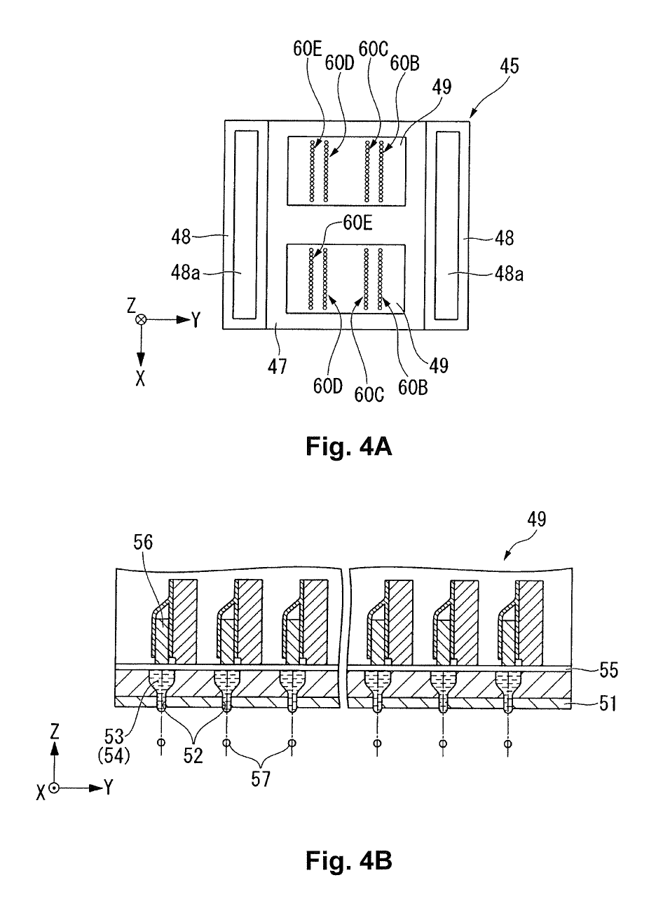

FIG. 4A is a schematic plan view showing the head unit. Two droplet discharge heads 49 are disposed a gap apart in the sub scan direction (the X direction) on the head unit 47 as shown in FIG. 4A, and nozzle plates 51 (see FIG. 4B) are disposed on the surfaces of the droplet discharge heads 49. A plurality of nozzles 52 are formed in arrays on the nozzle plates 51. In the present embodiment, disposed on each of the nozzle plates 51 at intervals in the Y direction are nozzle rows 60B to 60E in which 15 nozzles 52 are disposed along the sub scan direction. The nozzle rows 60B to 60E in the two droplet discharge heads 49 are disposed in straight lines along the X direction. The nozzle rows 60B, 60E are disposed at equal intervals from the center of the carriage 45 in the Y direction. Similarly, the nozzle rows 60C, 60D are disposed at equal intervals from the center of the carriage 45 in the Y direction. Therefore, the distance between the curing unit 48 on the +Y side and the nozzle row 60B, and the distance between the curing unit 48 on the −Y side and the nozzle row 60E, are equal. Also equal are the distance between the curing unit 48 on the +Y side and the nozzle row 60C, and the distance between the curing unit 48 on the −Y side and the nozzle row 60D.

FIG. 4B is a partial schematic cross-sectional view for describing the structure of the droplet discharge heads. The droplet discharge heads 49 include the nozzle plates 51, and nozzles 52 are formed in the nozzle plates 51, as shown in FIG. 4B. In the top sides of the nozzle plates 51, in positions facing the nozzles 52, cavities 53 communicated with the nozzles 52 are formed. The functional liquid (the liquid substance) 54 is supplied to the cavities 53 of the droplet discharge heads 49.

On the top sides of the cavities 53, a vibrating plate 55 is provided for vibrating vertically and enlarging and reducing the volumes in the cavities 53. On the top side of the vibrating plate 55 at locations facing the cavities 53 are provided piezoelectric elements 56 which vertically expand and contract to cause the vibrating plate 55 to vibrate. The piezoelectric elements 56 vertically expand and contract to apply pressure to and vibrate the vibrating plate 55, and the vibrating plate 55 enlarges and reduces the volumes in the cavities 53 to apply pressure the cavities 53. The pressure in the cavities 53 thereby fluctuates, and the functional liquid 54 supplied into the cavities 53 is discharged through the nozzles 52.

The curing units 48 are disposed at positions enclosing the head unit 47 from both sides in the main scanning direction (the relative movement direction), as shown in FIGS. 3B and 4A. Radiation devices for radiating ultraviolet rays which cure the discharged droplets are disposed inside the curing units 48. The radiation devices are configured from light-emitting units, radiator plates, or the like. The light-emitting units are provided with arrays of numerous LED (Light Emitting Diode) elements. Supplied with electric power, these LED elements emit ultraviolet light which is the light of ultraviolet rays. Radiation holes 48a are formed in the bottom surfaces of the curing units 48. The ultraviolet light emitted by the radiation devices is radiated from the radiation holes 48a onto the semiconductor substrates 1.

When the droplet discharge heads 49 receive a nozzle drive signal for controllably driving the piezoelectric elements 56, the piezoelectric elements 56 elongate and the vibrating plate 55 reduces the volumes in the cavities 53. As a result, an amount of functional liquid 54 equal to the reduced volume is discharged as droplets 57 from the nozzles 52 of the droplet discharge heads 49. The semiconductor substrates 1 coated with functional liquid 54 are irradiated with ultraviolet light from the radiation holes 48a, and the functional liquid 54 containing the curing agent is solidified or cured.

### Storage Unit

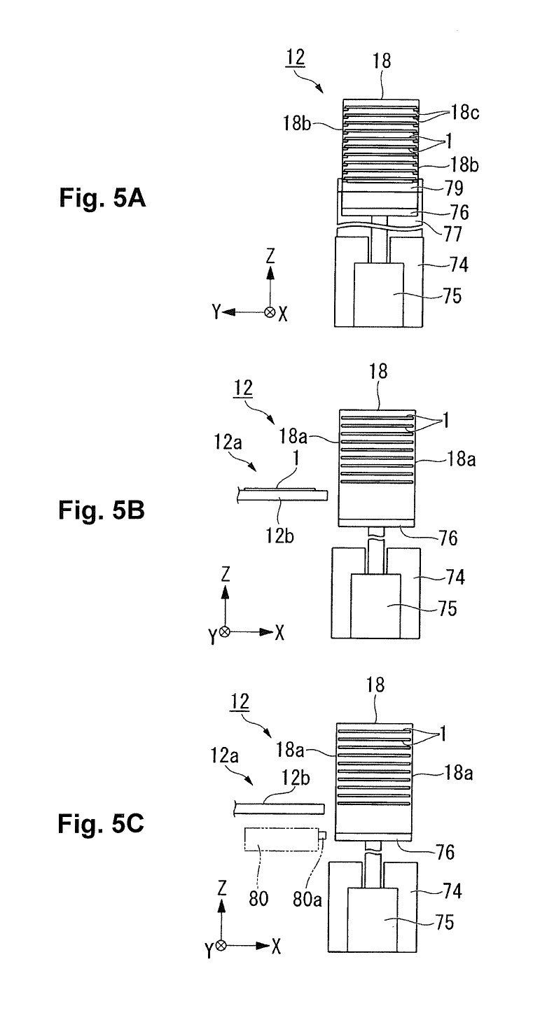

FIG. 5A is a schematic front view showing the storage unit, and FIGS. 5B and 5C are schematic side views showing the storage unit. The storage unit 12 comprises a base stand 74 as shown in FIGS. 5A and 5B. A raising/lowering device 75 is installed inside the base stand 74. A device similar to the raising/lowering device 16 installed in the feeding part 8 can be used as the raising/lowering device 75. A raising/lowering plate 76 is installed in connection with the raising/lowering device 75 on the top side of the base stand 74. The raising/lowering plate 76 is raised and lowered by the raising/lowering device 75. The rectangular parallelepiped storage container 18 is installed on top of the raising/lowering plate 76, and the semiconductor substrates 1 are stored inside the storage container 18. The same container as the storage container 18 installed on the feeding part 8 is used as the storage container 18.

The semiconductor substrates 1 placed by the transporting part 13 on the rails 12b as a relay location are moved by the transporting part 13 from the rails 12b to the storage container 18. An extrusion device 80 comes to be positioned below the rails 12b and between the rails 12b, 12b in the Y direction as shown in FIG. 5C, for example, after being moved by the transporting part 13 into the path from the rails 12b to the storage container 18, and this extrusion device 80, which has the same configuration as the extrusion device 23 described above, is capable of being raised by a raising/lowering device (not shown) to a position facing the semiconductor substrates 1 in the position of the aforementioned path. The extrusion device 80 may be kept queued below the rails 12b when the transporting part 13 places the semiconductor substrates 1 on the rails 12b, and when the transporting part 13 retreats from the rails 12b, the semiconductor substrates 1 may be moved to the storage container 18 by raising the extrusion device 80 to face the side surface of the semiconductor substrates 1 and causing an extrusion pin 80a to protrude in the +X direction.

As described above, semiconductor substrates 1 are repeatedly stored in the storage container 18 and the storage container 18 is repeatedly moved in the Z direction by the raising/lowering device 75, and after a predetermined number of semiconductor substrates 1 have been stored in the storage container 18, the operator replaces the storage container 18 containing the stored semiconductor substrates 1 with an empty storage container 18. The operator can thereby carry a plurality of semiconductor substrates 1 all at once to the next step.

### Transporting Part

Next, the transporting part 13 for conveying the semiconductor substrates 1 is described according to FIGS. 1, 6, and 7.

The transporting part 13 comprises a support member 83 provided to the ceiling of the device, and installed within the support member 83 is a rotation mechanism configured from a motor, an angle detector, a decelerator, and other components. The output shaft of the motor is connected with the decelerator, and the output shaft of the decelerator is connected with a first arm part 84 disposed in the bottom side of the support member 83. The angle detector is installed connected with the output shaft of the motor, and the angle detector detects the rotation angle of the output shaft of the motor. The rotation mechanism can thereby detect the rotation angle of the first arm part 84 and cause the first arm part 84 to rotate to a desired angle.

A rotation mechanism 85 is installed at the end of the first arm part 84 on the side opposite the support member 83. The rotation mechanism 85 is configured from a motor, an angle detector, a decelerator, and other components; and the rotation mechanism 85 as the same function as the rotation mechanism installed within the support member 83. The output shaft of the rotation mechanism 85 is connected with a second arm part 86. The rotation mechanism 85 can thereby detect the rotation angle of the second arm part 86 and cause the second arm part 86 to rotate to a desired angle.

A raising/lowering device 87 is disposed at the end of the second arm part 86 on the side opposite the rotation mechanism 85. The raising/lowering device 87 comprises a linear movement mechanism and can extend and retract by the driving of the linear movement mechanism. The same mechanism as that of the raising/lowering device 16 of the feeding part 8, for example, can be used as this linear movement mechanism.

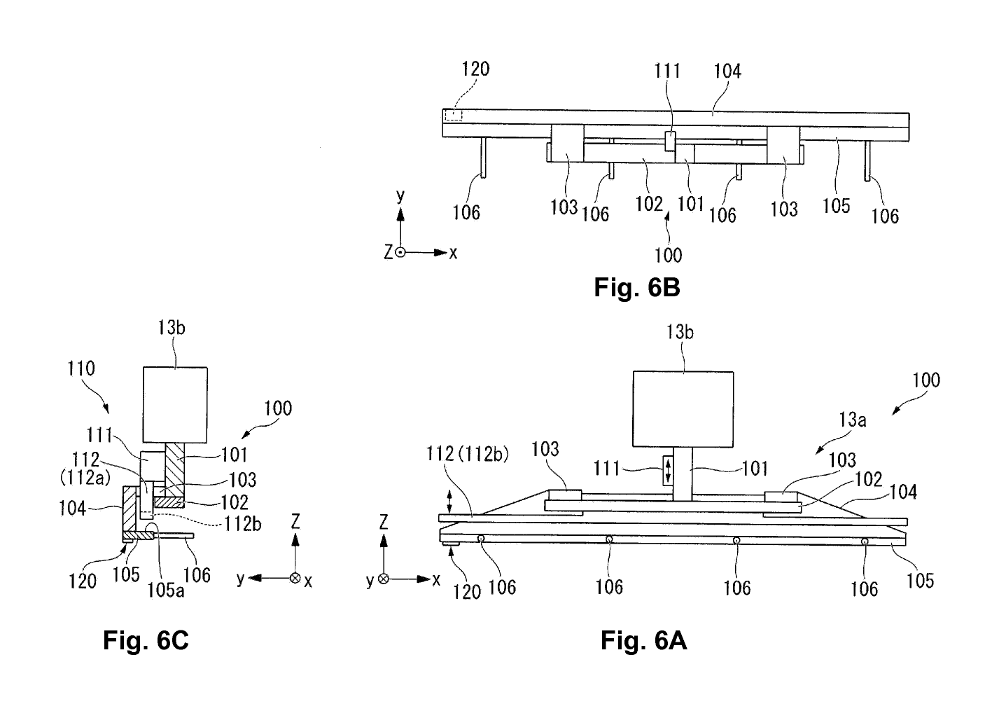

FIG. 6A is a front view wherein the grasping part 13a is provided to the −Z side of the arm part 13b, FIG. 6B is a plan view (the arm part 13b is not shown), and FIG. 6(c) is a left side view.

The grasping part 13a is provided so as to be capable of rotational movement in a θZ direction (the rotational direction around the Z axis) relative to the arm part 13b, and the position of the grasping part 13a within the XY plane varies; therefore, for the sake of convenience in the description, one direction parallel with the XY plane is designated as the x direction, and the direction parallel to the XY plane and orthogonal to the x direction is designated as the y direction (the Z direction remains the same).

The grasping part 13a comprises a stationary part 100 which is capable of rotating in the θZ direction relative to the arm part 13b and which is used in a stationary state when a semiconductor substrate 1 is grasped, and a moving part 110 provided to be free to move in the Z direction relative to the stationary part 100.

The stationary part 100 is configured with a Z-axis member 101, a suspension member 102, linking members 103, a linking plate 104, a holding plate 105, and fork parts 106 as its primary components. The Z-axis member 101 is made to extend in the Z direction and is provided to the arm part 13b so as to be capable of rotating around the Z axis. The suspension member 102 is formed into a plate shape extending in the x direction, and is fixed to the bottom end of the Z-axis member 101 in the center of the x direction. The linking plate 104 is disposed at a gap from and parallel to the suspension member 102, and is linked with the suspension member 102 at both x-directional ends by the linking members 103. The holding plate 105 is formed into a plate shape extending in the x direction, and is fixed to the bottom end of the linking plate 104 at the +y side edge in the surface on the +Z side, as shown in FIG. 6(c). In the surface on the +Z side of the holding plate 105, the end edge on the −y side constitutes a holding surface 105a when holding a semiconductor substrate 1.

The fork parts 106, which support the bottom surface (the −Z side surface) of the semiconductor substrate 1 from below, the semiconductor substrate 1 being held by the holding surface 105a; are made to extend in the y direction from the −y side of the holding plate 105, and a plurality of fork parts (four in this case) are provided at intervals in the x direction. The number of fork parts 106 and intervals at which they are arranged are set so as to enable support in at least one location, and preferably two or more, in the length direction even when the length of the semiconductor substrate 1 fluctuates according to the model type and other factors.

The moving part 110 is configured with a raising/lowering part 111 and a grasping plate 112 as primary components. The raising/lowering part 111, which is configured from an air cylinder mechanism or the like, is raised and lowered along the Z-axis member 101. The grasping plate 112, which is provided so as to be capable of being raised and lowered integrally with the raising/lowering part 111, has a width which is shorter than the x-directional gap length between the linking members 103, 103 and smaller than the gap between the suspension member 102 and the linking plate 104. The grasping plate 112 comprises an insertion part 112a inserted so as to be capable of moving in the Z direction within the gap between the linking members 103, 103 and the gap between the suspension member 102 and linking plate 104, and a holding plate 112b positioned below the insertion part 112a and extending in the x direction below the suspension member 102 at substantially the same length as the holding plate 105, the insertion part 112a and the holding plate 112b being formed integrally.

The grasping plate 112, comprising the insertion part 112a and the holding plate 112b, moves integrally in the Z direction along with the raising and lowering of the raising/lowering part 111. When the grasping plate 112 has been lowered, one end edge of the semiconductor substrate 1 can be held and grasped between the grasping plate 112 and the drive controller 115, and when the grasping plate 112 has been raised, the grasping plate 112 separates from the drive controller 115 and the grasp on the semiconductor substrate 1 is thereby released.

By inputting the output of the detector disposed on the transporting part 13 to detect the position and orientation of the grasping part 13a, and driving the rotation mechanism 85 and other components to move the grasping part 13a to a predetermined position, the semiconductor substrate 1 grasped by the grasping part 13a can be conveyed to a predetermined processing part.

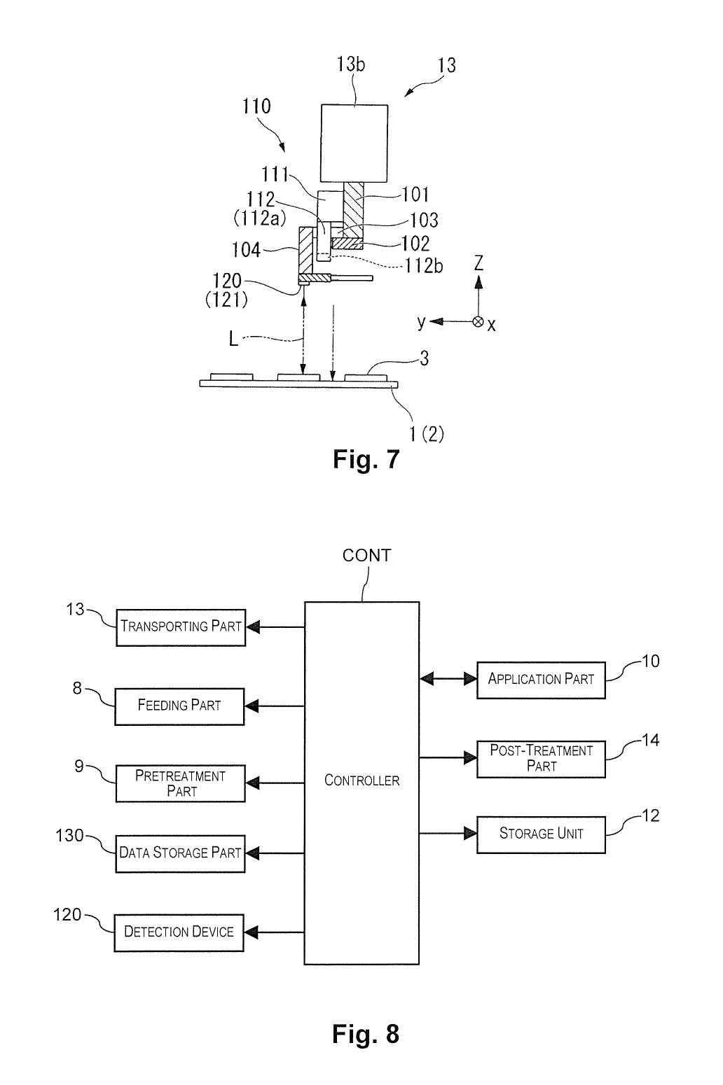

The transporting part 13 is also provided with a detection device (detection part) 120 for detecting whether or not a semiconductor substrate 1 is in the above-mentioned treatment devices. The detection device 120 has a distance gauge 121 for measuring the distance to a reflecting position (a surface position) by projecting detection light L of infrared light, laser light, or the like onto the opposing semiconductor substrate 1 and receiving the reflected light of the detection light L reflected by the semiconductor substrate 1, as shown in FIG. 7. The measurement results of the distance gauge 121 are outputted to the controller CONT. From the results measured by the distance gauge 121 (e.g., the difference with the distance to the placement part where the semiconductor substrate 1 is placed), the controller detects whether or not there is a semiconductor substrate 1 in the measured treatment device. The presence of a placed object can be detected in the treatment devices, but when the measured distance is an abnormal value, it is also possible to detect problems with the placement caused by adhesion or lifting of foreign substances or other factors.

FIG. 8 is a block diagram of the control system according to the printing device 7.

The actions of the above-described feeding part 8, pretreatment unit 9, coating unit 10, post-processing unit 14, and storage unit 12 are controlled collectively by the controller CONT, as shown in FIG. 8. Connected to the controller CONT is a data containment part (a storage unit) 130 for containing (storing) position information of where the semiconductor substrate 1 is placed along with the process in the plurality of treatment devices described above in the printing device 7. Processing history information in the above-described treatment devices is also updated as needed and contained in the data containment part 130 in correlation with the semiconductor substrate 1 being processed. For each treatment device, the data containment part 130 also stores coordinates in the XY plane of a measurement device MA (see FIG. 1A) for measuring whether or not there is a semiconductor substrate 1 placed in the treatment devices. This measurement device MA is set in the surface of each semiconductor device 3 so as to increase the difference in distances to the substrate placement surfaces of the placement parts where the semiconductor substrate 1 is placed in the treatment devices. The measurement devices MA in the surfaces of the semiconductor devices 3 is derived based on layout information of the semiconductor substrate 1 wherein the semiconductor devices 3 are disposed on the substrate 2, the layout information being contained in advance in the data containment part 130.

### Print Method

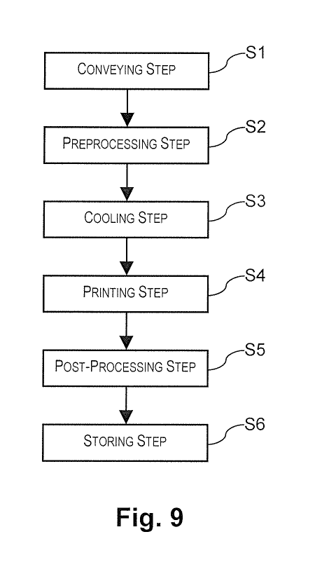

A print method using the above-described printing device 7 is described next using FIG. 9. FIG. 9 is a flowchart for showing the print method.

As shown in the flowchart of FIG. 9, the print method is composed primarily of a conveying step 51 (transporting step) for conveying the semiconductor substrate 1 from the storage container 18, a preprocessing step S2 for performing pretreatment on the surface of the conveyed semiconductor substrate 1, a cooling step S3 for cooling the semiconductor substrate 1 whose temperature has risen in the preprocessing step S2, a printing step S4 for drawing and printing various markings on the cooled semiconductor substrate 1, a post-processing step S5 for performing post-processing on the semiconductor substrate 1 on which various markings have been printed, and a storing step S6 for storing the semiconductor substrate 1 that has undergone post-processing in the storage container 18.

In the present embodiment, before the series of processes described above, whether or not there is a semiconductor substrate 1 being processed or finished processing in the above-described treatment devices is detected during the initial action (during startup) of the printing device 7.

Specifically, the controller CONT controls the transporting part 13 and causes the detection device 120 to move to a position facing the position where the semiconductor substrate 1 where the semiconductor substrate 1 is placed when remaining in the substrate placement part of one of the treatment devices. At this time, the controller CONT, acting as an adjustment part, refers to the coordinates of a measurement device MA of the semiconductor substrate 1 kept in the data containment part 130, adjusts the transporting part 13 so that the region detected by the detection device 120 includes the measurement device MA, and detects whether or not there is a semiconductor substrate 1 in this coordinate position.

At this time, coordinate data whereby the presence of semiconductor substrates 1 is detected in the treatment devices, and presence data (detection data) of the semiconductor substrates 1 corresponding to the coordinate data, are contained in the data containment part 130 for each treatment device in a state of being correlated with each other. Based on the above-described data contained in the data containment part 130, the controller CONT acts as a determination part to determine whether or not semiconductor substrates 1 remain in the above-described treatment devices, and determines the treatment action to be performed next.

Specifically, when it is determined that a semiconductor substrate 1 remains in any of the treatment devices, the controller CONT specifies the treatment device in which the semiconductor substrate 1 remains on the substrate placement part from the coordinates of the above-described data contained in the data containment part 130, and references the processing history information of the semiconductor substrate 1 in the treatment device contained in the data containment part 130. When a predetermined time has elapsed following the time of the processing performed on the semiconductor substrate 1, the controller CONT then conveys the semiconductor substrate 1 to be unloaded to the storage unit 12 and ejects the semiconductor substrate 1. When the elapsed time following the time of the process performed on the semiconductor substrate 1 is less than the predetermined time, the controller CONT confirms that the process in the treatment device is complete, and then transitions to the next step.

The controller CONT then causes loads a new semiconductor substrate 1 to be processed onto the feeding part 8, after confirming that there is no risk of interference with another semiconductor substrate 1, or particularly that there is no risk of interference in the substrate placement part in the pretreatment unit 9 which has a high risk of interference with the semiconductor substrate 1 that will be processed next, based on the detection results of the detection device 120.

After the semiconductor substrate 1 has been loaded, the semiconductor substrate 1 is subjected to pretreatment (a surface reforming process in a heated state) in the preprocessing step S2, then cooled in the cooling step S3, and the process of printing various markings is performed on the semiconductor devices 3 in the printing step S4. Having undergone the process of printing the various markings, the semiconductor substrate 1 is subjected to post-processing in the post-processing step S5, then stored in the storage container 18 in the storing step S6, and conveyed out via the storage container 18.

As described above, in the present embodiment, since the detection device 120 is provided to the transporting part 13, there is no need to provide means for detecting the presence of the semiconductor substrate 1 with each treatment device, which can contribute to reducing the size and cost of the device. In the present embodiment, when a semiconductor substrate 1 is conveyed to the treatment devices, in the case that no semiconductor substrate 1 remains, the semiconductor substrate 1 is conveyed to the treatment devices by the transporting part 13 in order to perform predetermined processes on the semiconductor substrate 1. For example, in the case that a semiconductor substrate 1 remains in one of the treatment devices, the semiconductor substrate 1 can be stopped from being conveyed to that treatment device in order to avoid interference with the remaining semiconductor substrate 1, and safety can be improved.

In the present embodiment, interference of semiconductor substrates 1 during the initial action can be avoided because the presence of semiconductor substrates 1 that are being process or that have finished processing in the treatment devices is detected during the initial action of the printing device 7. Furthermore, in the present embodiment, since measurement devices MA are measured sequentially based on the layout information of semiconductor devices 3 and the like disposed on the surface of the semiconductor substrate 1, there is no need to separately and manually input the detection region of the detection device 120 made possible by the transporting part 13, and operating efficiency can be improved.

A preferred embodiment according to the present invention was described above with reference to the accompanying drawings, but the present invention is of course not limited to these examples. The shapes, combinations, and other characteristics of the configurational members shown in the above examples are merely one example, and various modifications can be made based on design requirements and other factors within a range that does not deviate from the scope of the present invention.

For example, the embodiment described above presented an example of a procedure in which the presence of semiconductor substrates 1 that are being process or that have finished processing in the treatment devices is detected during the initial action (during startup) of the printing device 7, but the procedure is not limited to this example, and the detection process can be performed appropriately according to conditions, such as a procedure in which the presence of semiconductor substrates 1 is detected during another operation following error processing, for example.

The embodiment described above was configured such that the distance gauge 121 in the detection device 120 projects detection light L onto the surface of the semiconductor substrate 1, but the configuration is not limited to this example, and the configuration may use an electrostatic capacitance distance gauge 121, for example.

In the embodiment described above, ultraviolet-curing ink was used as UV ink, but the present invention is not limited to this option, and it is possible to use various active light ray curing inks with which visible light rays or infrared light rays can be used as the curing light.

Similarly for the light source, various active light sources which emit visible light or other active light can be used, i.e., an active light ray radiator can be used.

The term “active light ray” in the present invention is not particularly limited as long as its radiation can provide energy can create initiators in the ink, and such rays broadly encompass a rays, y rays, X rays, ultraviolet rays, visible light rays, electron beams, and the like. Of these examples, ultraviolet rays and electron beams are preferred for the sake of curing sensitivity and ease of acquiring the equipment, and ultraviolet rays in particular are preferred. Therefore, for the active light ray curing ink, it is preferable to use ultraviolet ray curing ink that can be cured by irradiation with ultraviolet rays, as is the case in the present embodiment.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A printing device comprising:
a plurality of treatment devices with each of the treatment devices being configured and arranged to perform a treatment on a base material;
a transporting part configured and arranged to transport the base material between the treatment devices;
a detection part configured and arranged to perform a detecting action in placement parts in the treatment devices, the detection part being provided to the transporting part;
a storage unit configured and arranged to correlate and store a position and detection data detected by the detection part;
a determination part configured and arranged to determine presence of the base material in the treatment devices based on the data stored in the storage unit; and
a controller configured to determine a treatment action based on determination result of the determination part.

2. The printing device according to claim 1, wherein
the controller is configured to control driving of the transporting part during an initial action to determine the presence of the base material in the treatment devices.

3. The printing device according to claim 1, further comprising
an adjustment part configured and arranged to adjust the position of the base material detected by the detection part, based on layout information of a member disposed on a surface of the base material.

4. The printing device according to claim 1, wherein
based on respective treatment histories in the treatment devices, the controller is configured
to cause the base material which is in one of the treatment devices to be transported to another of the treatment devices that performs an unloader process as the treatment action, when a predetermined time has elapsed, and
to transition to the treatment action after confirming that treatment by the treatment device is complete, when a predetermined time has not elapsed.

5. The printing device according to claim 1, wherein
the treatment devices include a loader device that transports a new base material to be processed, and a pretreatment device that performs a predetermined pretreatment on the base material transported from the loader device, and
the controller is configured to cause the base material to be transported from the loader device to the pretreatment device based on the determination result of the determination unit.

6. The printing device according to claim 1, wherein
the treatment devices include a discharge device configured and arranged to discharge droplets on a semiconductor device provided to a surface of the base material.

7. A printing device comprising:
a plurality of treatment devices configured and arranged to perform treatments related to printing on a base material, the treatment devices including a discharge device configured and arranged to discharge droplets of a liquid substance that is curable by active light onto the base material;
a transporting part configured and arranged to transport the base material between the treatment devices;
a detection part configured and arranged to perform a detecting action in placement parts in the treatment devices, the detection part being provided to the transporting part;
a storage unit configured and arranged to correlate and store a position and detection data detected by the detection part;
a determination part configured and arranged to determine presence of the base material in the treatment devices based on the data stored in the storage unit; and
a controller configured to determine a treatment action based on determination result of the determination part.
